(19) United States
(12) Patent Application Publication
(10) Pub. No.: US 2015/0188116 A1
(43) Pub. Date: Jul. 2, 2015

(54) JOINT STRUCTURE, JOINING METHOD, SECONDARY BATTERY, AND METHOD OF MANUFACTURING SECONDARY BATTERY

(71) Applicant: Hitachi, Ltd., Tokyo (JP)

(72) Inventors: Akihiro Sato, Tokyo (JP); Satoshi Hirano, Tokyo (JP); Kenichi Okamoto, Tokyo (JP); Tsunenori Yamamoto, Tokyo (JP)

(73) Assignee: Hitachi, Ltd., Tokyo (JP)

(21) Appl. No.: 14/404,383

(22) PCT Filed: Apr. 22, 2013
(86) PCT No.: PCT/JP2013/061711

§ 371 Date: Nov. 26, 2014

(30) Foreign Application Priority Data
May 30, 2012 (JP) 2012-122859

(51) Int. Cl. H01M 2/26; B23K 20/12; H01M 2/30

(52) U.S. Cl. CPC H01M 2/266; H01M 2/30; B23K 20/12

(57) ABSTRACT

The present invention provides a joint structure, a joining method, a secondary battery, and a method for manufacturing a secondary battery, capable of improving routing performance and reducing electric resistance. The joint structure includes: a foil assembly 3 including a plurality of foils stacked one on top of the other; a connecting member 4 that fixes the foil assembly 3; and a holding member 5 disposed such that gaps in the foil assembly 3 in the stacking direction are brought into tight contact with each other between the connecting member 4 and the holding member 5. An upper surface 32 of the foil assembly 3, the connecting member 4, and the holding member 5 are joined integrally with each other to form a joint 6.

### TECHNICAL FIELD

The present invention relates to a joint structure, a joining method, a secondary battery, and a method of manufacturing a secondary battery.

### BACKGROUND ART

Nickel-metal hydride rechargeable batteries and lithium-ion secondary batteries are known as some types of secondary batteries. A nickel-metal hydride rechargeable battery or a lithium-ion secondary battery mainly includes a metallic current collector (a negative electrode) having a negative electrode active material layer formed on a surface thereof and another metallic current collector (a positive electrode) having a positive electrode active material layer formed on a surface thereof. The nickel-metal hydride rechargeable battery incorporates a nickel oxide for the positive electrode and a hydrogen storage alloy for the negative electrode. The lithium-ion secondary battery incorporates a lithium metal oxide for the positive electrode and a carbon material such as graphite for the negative electrode.

The metallic current collector (electrode plate) having the active material layer formed on the surface thereof has one edge on which a current collecting tab is formed, the current collecting tab establishing an electric connection to an external terminal of the secondary battery. In a battery having a cylindrical structure, for example, current collecting tabs are formed and wound at regular intervals around a band-shaped electrode plate. In a stacked battery, the current collecting tabs are formed on one edge of a strip-shaped electrode plate.

A predetermined number of current collecting tabs which are bundled together and the external terminal of the secondary battery are electrically connected to each other directly or via an electric wiring member.

Patent document 1 discloses a secondary battery that includes an electrode terminal, a plurality of electrode plates each of which arranged in juxtaposition with each other, and a plurality of stacked connecting plate members each having one end joined to the electrode terminal and the other end joined to the electrode plate to thereby electrically connecting the electrode terminal and the electrode plates. The stacked connecting plate members are folded in a meandering form between the electrode terminal and the electrode plates. Patent document 1 also discloses that the connecting plate members and the current collecting tabs of the electrode plates are joined together by, for example, ultrasonic welding.

Patent document 2 discloses a current collecting structure that includes a band-shaped electrode having a plurality strip-shaped current collecting leads on one side, the band-shaped electrode being wound into a spiral form, wherein the strip-shaped current collecting leads are sandwiched between one surface of a metallic flat plate ring and one surface of a metal disk, and the strip-shaped current collecting leads, the metallic flat plate, and the metal disk are welded together by a laser beam (laser welding).

A method of connecting an external terminal to a current collecting tab or a method of connecting the external terminal to the current collecting tab via an electric wiring member includes mechanical fastening represented by bolting and staking. Relating to such mechanical fastening, Patent document 3 discloses a stacked battery having a structure as follows. The stacked battery includes an electrode stack in which alternating layers of a positive electrode and a negative electrode are stacked with a separator interposed therebetween. A positive electrode current collecting tab formed of a metal foil extends from the positive electrode and a negative electrode current collecting tab formed of a metal foil extends from the negative electrode. The positive electrode current collecting tabs are clamped, while being overlapped each other, between a plate-shaped internal terminal that constitutes part of a positive electrode terminal and a plate-shaped positive electrode-side holding plate, thereby establishing an electric connection between the positive electrode and the positive electrode terminal via the positive electrode current collecting tab. The negative electrode current collecting tabs are clamped, while being overlapped each other, between a plate-shaped internal terminal that constitutes part of a negative electrode terminal and a plate-shaped negative electrode-side holding plate, thereby establishing an electric connection between the negative electrode and the negative electrode terminal via the negative electrode current collecting tab. Further, the stacked battery is structured such that on one of facing surfaces of the internal terminal of the positive electrode terminal and the positive electrode-side holding plate, a protrusion extending in a width direction of the positive electrode current collecting tab is provided and on the other one of the facing surfaces, a recess in which the protrusion is loosely fitted is provided, and the positive electrode current collecting tabs are disposed between the protrusion and the recess, and/or, structured such that on one of facing surfaces of the internal terminal of the negative electrode terminal and the negative electrode-side holding plate, a protrusion extending in a width direction of the negative electrode current collecting tab is provided and a recess in which the protrusion is loosely fitted is provided, and the negative electrode current collecting tabs are disposed between the protrusion and the recess.

### PRIOR ART DOCUMENTS

### Patent Documents

### Patent Document 1:

International Publication No. 2011/099491

Patent Document 2: JP-2001-118561-A

Patent Document 3: JP-2009-87612-A

### SUMMARY OF THE INVENTION

### Problem to be Solved by the Invention

In secondary batteries, the electrode plate is as thin as several micrometers to several millimeters and so is the current collecting tab extending from the electrode plate. The connection between the current collecting tab and the external terminal may be relatively easy when several to tens of the current collecting tabs are stacked; however, stacking hundreds of the current collecting tabs makes the connection between the current collecting tab and the external terminal difficult and aggravates workability involved in assembling the current collecting tabs in the battery can.

In the secondary battery disclosed in patent document 1, the current collecting tabs constitute a plurality of groups and the groups are each connected to the respective electric wiring members. Further, the electric wiring members are bundled up into an assembly for connecting on the external terminal side. This increases the number of steps to be performed and the current collecting tabs can be damaged in each step.

In the battery that includes a closed-bottom battery can in which the stack (the negative electrode and the positive electrode) is inserted and that is hermetically sealed by negative and positive external terminals disposed above the stack and by a lid member in which the two external terminals are fixed, a step is needed in which the electric wiring members are folded several times between the stacked current collecting tabs and the external terminals before being housed in place. This step needs to be performed carefully to ensure that the current collecting tabs and the electric wiring members are not damaged.

With the trend in secondary batteries toward greater capacities and larger current, a need exists for reducing electric resistance of the electric wiring member and the current collecting tab in order to reduce heat generated by the electric wiring member and the current collecting tab. To achieve reduced electric resistance, preferably the current collecting tab is directly connected to the external terminal. It is further preferable that the current collecting tab be made short.

When bolting or staking is employed for connecting the current collecting tab to the external terminal, a bolt is generally inserted in a direction identical to a stacking direction of the current collecting tabs to thereby make a connection with the external terminal. This involves a risk of the current collecting tab being broken when the bolt is tightened. When a backing plate is inserted for making the connection as in patent document 3, contact may be insufficient between the backing plate and the current collecting tab or the external terminal. In addition, the mechanical fastening method results in large contact resistance occurring between the external terminal and the current collecting tab. Thus, it is difficult to minimize the electric resistance at the connection, so that a large voltage drop is involved when a large current is passed. This makes the mechanical fastening method inappropriate for a battery through which a large current of about 40 A or higher is passed.

Specifically, when a battery through which a large current of about 40 A or higher is passed is to be manufactured, preferably, a direct metallic joining method is employed instead of the mechanical fastening method in order to achieve reduction in electric resistance.

Resistance spot welding is a method of joining metals by melting the metals with resistance heat generated when electricity is passed therethrough while pressurizing both ends of the metals.

The nugget as a pool of molten metal has, however, a wide and shallow flat shape. Accordingly, when a large number of layers of the current collecting tabs is involved and the joint becomes thick, weld penetration in the thickness direction is insufficient, resulting in insufficient joining strength.

Laser welding uses laser beam energy to melt and join metals.

In a structure connecting the current collecting tab directly to the external terminal, however, the energy loaded during welding can be excessive and heat radiating properties of the joining metals are different. This causes spatter to tend to occur. The resultant spatter can melt the separator or may be left in the electrode group as foreign matter, causing a short circuit to occur.

When the current collecting tab is sandwiched between the current collecting plate and the backing plate for laser welding as in patent document 2, spatter tends to occur resulting in a short circuit as described above. When a plurality of foils are stacked one on another as in the current collecting tab, in particular, the tabs need to be brought in tight contact with each other to eliminate any gap therebetween. Furthermore, because the beam diameter is as small as 1 mm or less and energy density is extremely high in laser welding, deeper weld penetration can be obtained than in resistance spot welding, so that the a welding width is narrow. This makes it difficult to obtain a joining area required for a large current to flow.

Friction stir welding is a joining process in which a cylindrical tool having a protruding leading end is spun and pressed up against the joining materials, which generates friction heat that softens the joining materials, while the rotational force of the tool subjects the area around the joint to a plastic flow, thereby integrating the joining materials.

The friction stir welding process achieves a wider joining width, a greater joining area, and a deeper joint than in laser and other welding processes. The friction stir welding process is, therefore, suitable for a structure that passes a large current. Because the spinning tool is pressed against the joining metals, however, foils of a stack of thin foils such as the current collecting tab may be torn or burrs produced by the spinning tool may be left in surfaces around the joint.

It is an object of the present invention to provide a joint structure, a joining method, a secondary battery, and a method for manufacturing a secondary battery, capable of improving routing performance and reducing electric resistance.

### Means for Solving the Problem

To solve the foregoing problem, an aspect of the present invention provides a joint structure comprising: a foil assembly including a plurality of foils stacked one on top of the other; a connecting member that fixes the foil assembly; and a holding member disposed such that gaps in the foil assembly in the stacking direction are brought into tight contact with each other between the connecting member and the holding member. In the joint structure, an end face of the foil assembly, the connecting member, and the holding member are joined integrally with each other.

An aspect of the present invention provides a joining method comprising: disposing a holding member and a connecting member so as to bring gaps in a foil assembly in a stacking direction thereof into tight contact with each other, the foil assembly including a plurality of foils stacked one on top of the other; and joining an end face of the foil assembly, the connecting member, and the holding member integrally with each other.

An aspect of the present invention provides a secondary battery comprising: a stack including metallic current collectors stacked one on top of the other; current collecting tabs each extending from the respective metallic current collectors; an external terminal that fixes the current collecting tabs; a holding member disposed such that gaps in the current collecting tabs in the stacking direction are brought into tight contact with each other between the external terminal and the holding member; and a joint disposed, relative to the external terminal, on a side different from a side on which the stack is disposed, the joint joining the current collecting tabs, the external terminal, and the holding member.

An aspect of the present invention provides a method of manufacturing a secondary battery, the method comprising: disposing an external terminal and a cover block so as to bring gaps in current collecting tabs in a stacking direction thereof into tight contact with each other, the current collecting tabs extending from metallic current collectors; and joining an end face of the current collecting tabs, the external terminal, and the cover block integrally with each other, on a side different from a side on which a stack including the metallic current collectors stacked one on top of the other is disposed, relative to the external terminal.

### Effect of the Invention

The present invention can provide a joint structure, a joining method, a secondary battery, and a method for manufacturing a secondary battery, capable of improving routing performance and reducing electric resistance.

### BRIEF DESCRIPTION OF THE DRAWINGS

FIG. 1 is a partially cutaway perspective view showing a secondary battery according to a first embodiment of the present invention with a housing partially cut away to expose an interior.

FIG. 2 is a cross-sectional view taken along line A-A of the secondary battery according to the first embodiment of the present invention.

FIG. 3 is a partial enlarged schematic view showing a current collecting tab, an external terminal, a cover block, and an area therearound after joining.

FIG. 4 is a partial enlarged schematic view showing the current collecting tab, the external terminal, the cover block, and the area therearound before and during the joining.

FIG. 5 is a partial enlarged perspective view showing a current collecting tab, an external terminal, a cover block, and an area therearound in a secondary battery according to a second embodiment of the present invention.

FIGS. 6(a) and 6(b) are partial enlarged schematic views, each showing a current collecting tab, an external terminal, a cover block, and an area therearound in a secondary battery according to a third embodiment of the present invention.

### MODES FOR CARRYING OUT THE INVENTION

Modes for carrying out the present invention (hereinafter referred to as “embodiments”) will be described in detail below with reference to the accompanying drawings as may be necessary. In the drawings, like or corresponding parts are identified by the same reference numerals and descriptions for those parts will not be duplicated.

### First Embodiment

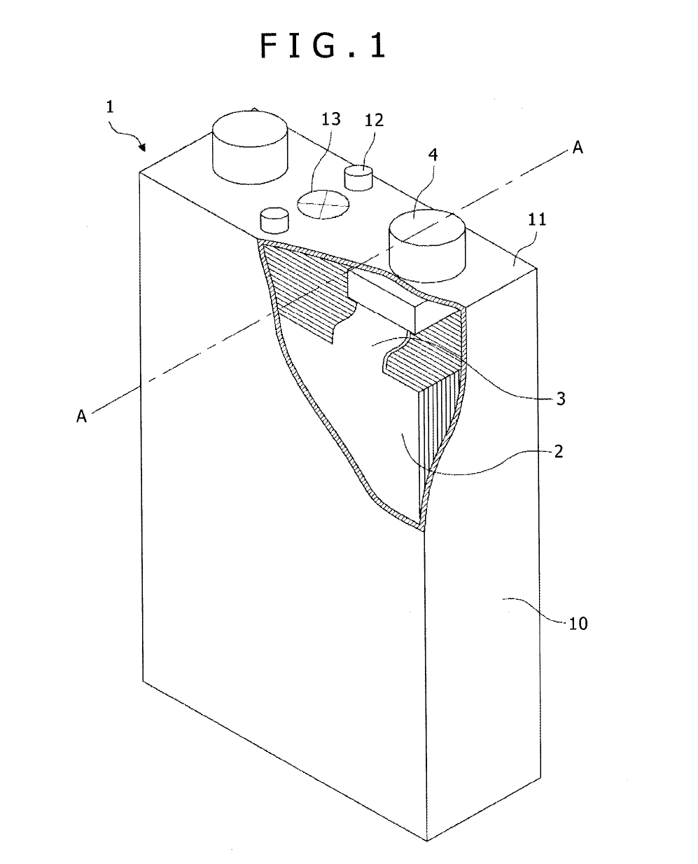

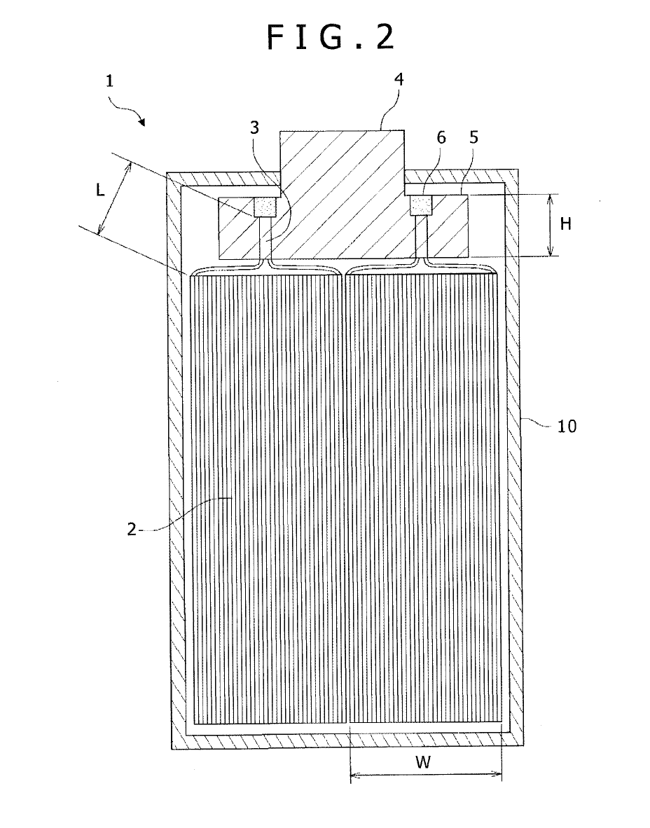

A secondary battery 1 according to a first embodiment will be described below with reference to FIGS. 1 and 2. FIG. 1 is a partially cutaway perspective view showing the secondary battery 1 according to the first embodiment with a housing partially cut away to expose an interior of the secondary battery 1. FIG. 2 is a cross-sectional view taken along line A-A (see FIG. 1) of the secondary battery 1 according to the first embodiment. In the following description, the secondary battery 1 according to the first embodiment is a lithium-ion secondary battery having a stacked electrode structure as shown in FIG. 1.

### Configuration of the Secondary Battery 1

The secondary battery 1 includes a stack 2, a current collecting tab 3, an external terminal 4, a cover block 5 (see FIG. 2 to be described later), a battery can 10, a lid plate 11, an electrolyte pouring hole plug 12, and a safety valve 13.

The stack 2 includes one metallic current collector (negative electrode) on which a negative electrode active material layer is formed, a separator that holds an electrolyte, and the other metallic current collector (positive electrode) on which a positive electrode active material layer is formed. The stack 2 is configured such that a plurality of negative electrode-side metallic current collectors and a plurality of positive electrode-side metallic current collectors alternately arranged in strip form and separated from one another by the separators.

A carbon material such as graphite, for example, may be used for the negative electrode active material of the negative electrode active material layer. A lithium metal oxide (e.g. LiCoO₂, LiMn₂O₄, and LiNiO₂), for example, may be used for the positive electrode active material of the positive electrode active material layer. Additionally, copper may, for example, be used for the negative electrode-side metallic current collectors and aluminum may, for example, be used for the positive electrode-side metallic current collectors. Dimensions and the number of layers of the stack 2 are determined according to battery capacity requirement as appropriate.

The current collecting tab 3 extends partially from an end portion of the metallic current collector of the stack 2. The current collecting tab 3 is, for example, formed integrally with the metallic current collector of the stack 2. It is noted that the current collecting tab extends from each of the metallic current collectors; however, FIGS. 1 and 2 show only part of the current collecting tabs for convenience sake.

In the following description, the current collecting tab formed on the negative electrode-side metallic current collector will be referred to as a negative electrode current collecting tab and the current collecting tab formed on the positive electrode-side metallic current collector will be referred to as a positive electrode current collecting tab. The negative electrode current collecting tab and the positive electrode current collecting tab will be collectively referred to as a current collecting tab.

The current collecting tabs 3 are joined to the external terminal 4. Specifically, the negative electrode current collecting tabs are bundled and joined to the external terminal 4 on the negative electrode side, and the positive electrode current collecting tabs are bundled and joined to the external terminal 4 on the positive electrode side. The number of current collecting tabs is determined according to the battery capacity of the secondary battery 1. For example, for the secondary battery 1 having a battery capacity of several tens to several hundreds of Ah, the number of current collecting tabs ranges from several tens to several hundreds.

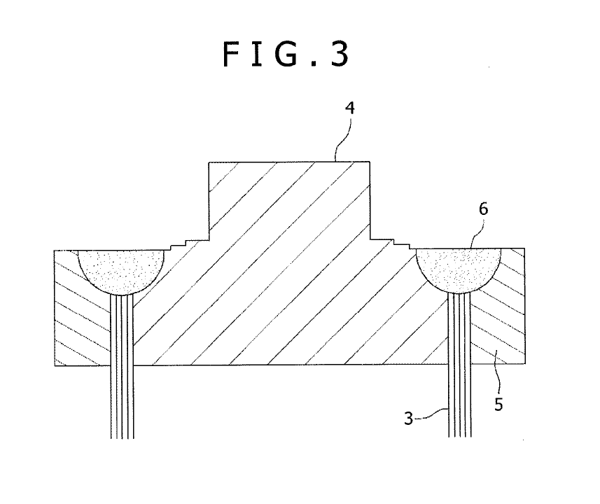

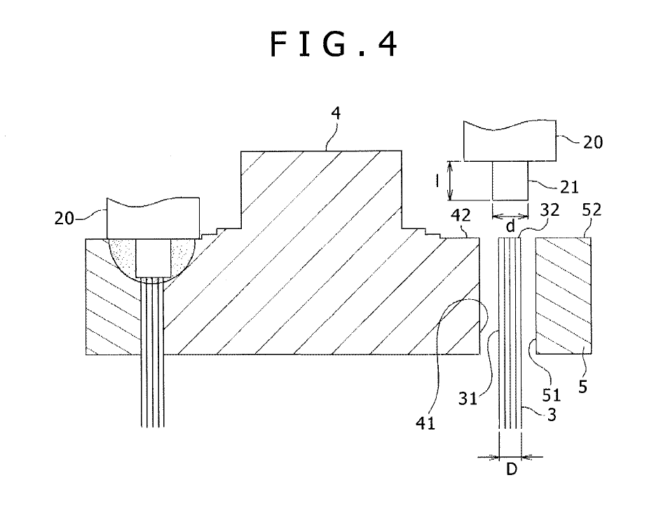

The external terminal 4 comprises a negative electrode-side external terminal joined to the negative electrode current collecting tab and a positive electrode-side external terminal joined to the positive electrode current collecting tab. The external terminal 4 is thereby joined to the metallic current collectors of the stack 2 via the current collecting tabs 3. It is noted that, as shown in FIG. 2, when the current collecting tabs 3 are joined to the external terminal 4, the cover block 5 is also joined together with the current collecting tabs 3 and the external terminal 4 to thereby form a joint 6. Specifically, the current collecting tabs 3 are clamped between the external terminal 4 and the cover block 5, under which condition the joint 6 is formed to thereby integrally join these parts together. The joining of the current collecting tabs 3, the external terminal 4, and the cover block 5 will be described later with reference to FIGS. 3 and 4.

The external terminals 4 on the positive electrode side and the negative electrode side are both disposed so as to protrude from an identical surface of the secondary battery 1, specifically, a surface of the lid plate 11. This accommodates wiring to the external terminals 4 within a single plane, so that a wiring space can be reduced.

For the external terminals 4 and the cover block 5, a base material identical to that for the respective current collecting tabs 3 is used. Specifically, a copper-based material (copper or copper alloy) is used for the negative electrode-side external terminal 4 and the negative electrode-side cover block 5 joined to the negative electrode current collecting tabs extending from the negative electrode-side metallic current collectors (copper). Alternatively, an aluminum-based material (aluminum or aluminum alloy) is used for the positive electrode-side external terminal 4 and the positive electrode-side cover block 5 joined to the positive electrode current collecting tabs extending from the positive electrode-side metallic current collectors (aluminum).

The battery can 10 and the lid plate 11 form a housing of the secondary battery 1. The battery can 10 contains therein the stack 2 and the electrolyte. The external terminals 4 are fixed to the lid plate 11 using fasteners (not shown) such as nuts. The electrolyte pouring hole plug 12 for hermetically sealing a pouring hole through which the electrolyte is poured and the safety valve 13 for releasing internal pressure in the battery can 10 in a non-steady state such as overcharging are disposed on the lid plate 11.

The battery can 10 has a rectangular parallelepiped shape to contain therein the stack 2 having a rectangular parallelepiped shape. Compared with wound type secondary batteries in which the metallic current collectors and the separators having a belt shape are wound into a cylindrical shape and housed in a cylindrical battery can, the stacked secondary battery 1 in which the metallic current collectors and the separators having a strip shape are stacked and housed in the battery can 10 having a rectangular parallelepiped shape, has no axial core or the like which is used for winding, to thereby advantageously provide a high energy density per volume.

The battery can 10 may be formed through, for example, impact press forming of aluminum alloy. If an aluminum-based alloy is used for the battery can 10, die cast forming may be employed to make the battery can 10. Stainless steel may still be used for the battery can 10. In addition to these metallic materials, resin not corroded by the electrolyte may be used for the battery can 10. Still alternatively, the resin may be applied to the surface of a metallic material.

### Joining of the Current Collecting Tabs 3, the External Terminals 4, and the Cover Blocks 5

The following describes the joining of the current collecting tabs 3, the external terminals 4, and the cover blocks 5.

Referring to FIG. 2, the stack 2 is broadly classified into two groups in the battery can 10. The negative electrode current collecting tabs of the stack 2 of one group are joined to one end of the negative electrode-side external terminals 4 and the negative electrode current collecting tabs of the stack 2 of the other group are joined to the other end of the negative electrode-side external terminals 4. Similarly, the positive electrode current collecting tabs of the stack 2 of one group are joined to one end of the positive electrode-side external terminals 4 and the positive electrode current collecting tabs of the stack 2 of the other group are joined to the other end of the positive electrode-side external terminals 4.

The current collecting tabs 3 extending from the metallic current collectors of the stack 2 are bent substantially at 90° so as to extend along the stacking direction of the stack 2 and are further bent in a direction opposite to the direction bent last, substantially at 90°, so as to extend along a side surface 41 (see FIG. 4) of the external terminal 4. This arrangement achieves a configuration in which the connecting plate members are not folded in a meandering form, unlike the arrangement in the secondary battery disclosed in patent document 1 (to state the foregoing differently, the current collecting tabs 3 are not bent substantially at 180° relative to a bent direction).

This results in the current collecting tabs 3 not being bent in a meandering form, unlike the arrangement disclosed in patent document 1, thus improving routing performance of the current collecting tabs 3 and assemblability of the secondary battery 1. The configuration further reduces a space occupied by the current collecting tabs 3 in the battery can 10, thereby advantageously reducing the size of the secondary battery 1 and increasing energy density per volume.

As shown in FIG. 2, for example, one out of the current collecting tabs 3, which has the longest length, can have a length L that is substantially equal to half of a thickness W in the stacking direction of the stack 2 plus a height H of the external terminal 4 (cover block 5) (W/2+H).

As such, compared with the second battery disclosed in patent document 1, the length of the current collecting tabs 3 (a length from the metallic current collector of the stack 2 to the joint 6) can be made shorter to thereby reduce heat generated by the current collecting tabs 3 through electric resistance.

The shortened current collecting tabs 3 can reduce thermal resistance of the current collecting tabs 3. This allows heat in the stack 2 to be transferred to the external terminals 4 via the current collecting tabs 3 and causes the external terminals 4 to function as a heat sink. Thus, an excessive temperature rise in the stack 2 can be prevented and thermal damage of the stack 2 can be prevented.

The following describes the joint 6 of the current collecting tabs 3, the external terminal 4, and the cover block 5 with reference to FIG. 3. FIG. 3 is a partial enlarged schematic view showing the current collecting tabs 3, the external terminal 4, and the cover block 5, and an area therearound after joining.

As shown in FIG. 3, an electric connection between the current collecting tabs 3 and the external terminal 4 is established by the joint 6 formed through friction stir welding.

The formation of the joint 6 through the friction stir welding reduces, as compared with, for example, the mechanical fastening as in patent document 3, electric resistance occurring in the joining (fastening) of the current collecting tabs 3 and the external terminal 4, so that heat generated by electric resistance of the joint 6 can be reduced. Still, heat generation in the joint 6 can prevent an excessive temperature rise in the stack 2 and thermal damage of the stack 2 by causing the external terminal 4 to function as a heat sink.

Additionally, because thermal resistance in the joint 6 can be reduced, heat in the stack 2 is transferred to the external terminals 4 to thereby cause the external terminal 4 to function as a heat sink. Thus, an excessive temperature rise in the stack 2 can be prevented and thermal damage of the stack 2 can be prevented.

### Method of Joining the Current Collecting Tabs 3, the External Terminals 4, and the Cover Blocks 5

The following describes a method of joining the current collecting tabs 3 and the external terminals 4 with reference to FIG. 4. FIG. 4 is a partial enlarged schematic view showing the current collecting tabs 3, the external terminal 4, the cover block 5, and the area therearound before and during the joining.

As shown on the right-hand side in FIG. 4, the current collecting tabs 3 in a bundle are disposed between the side surface 41 of the external terminal 4 and a side surface 51 of the cover block 5 and the cover block 5 is pressed toward the external terminal 4. This generates a pressing force acting in the stacking direction of the bundled current collecting tabs 3, so that the current collecting tabs 3 are brought into tight contact with each other without gaps therebetween and fixed to the side surface 41 of the external terminal 4.

A rotating tool leading end 21 of a rotating tool 20 that spins at high speed is then inserted from an upper side of the fixed current collecting tabs 3, the external terminal 4, and the cover block 5 (the side of an upper surface 32 of the current collecting tabs 3, an upper surface 42 of the external terminal 4, and an upper surface 52 of the cover block 5) (see the left-hand side of FIG. 4). The rotating tool 20 is moved linearly along the upper surface 32 of the current collecting tabs 3 (in a direction perpendicular to the paper surface of the FIG. 4) to thereby form the joint 6.

The size (width, depth) of the joint 6 formed through friction stir welding is determined depending on the shape of the rotating tool leading end 21. The rotating tool leading end 21 of the rotating tool 20 has a diameter d that is greater than a thickness D of the current collecting tabs 3 (specifically, d>D). This forms the joint 6 that joins the current collecting tabs 3, the external terminal 4, and the cover block 5.

The rotating tool leading end 21 of the rotating tool 20 needs only to have a length 1 set so that the electric resistance in the joint between the current collecting tabs 3 and the external terminal 4 is small, for example, set to be greater than the thickness D of the current collecting tabs 3 (specifically, I>D).

As described above, the joining method according to the embodiment arranges the cover block 5 and the rotating tool 20 such that the direction in which the cover block 5 is pressed differs from the direction in which the rotating tool 20 is inserted.

Assume a case in which, for joining, the direction in which the cover block 5 is pressed is identical to the direction in which the rotating tool 20 is inserted (for example, the rotating tool leading end 21 of the rotating tool 20 is inserted in a direction perpendicular to a plane 31 of the current collecting tabs 3 from the cover block 5) In this case, the cover block 5 needs to be fixed to the current collecting tabs 3 and the external terminal 4, while a space is allocated in the cover block 5 for inserting and moving the rotating tool 20, which does not allow an entire surface of the cover block 5 to be pressed toward the current collecting tabs 3. Hence a difficulty encountered in bringing the current collecting tabs 3 in tight contact with each other.

In contrast, in the joining method according to the embodiment, the direction in which the cover block 5 is pressed differs from the direction in which the rotating tool 20 is inserted. This enables uniform pressure on the entire surface of the cover block 5, so that the current collecting tabs 3 can be easily brought into tight contact with each other without gap therebetween.

In addition, in the joining method according to the embodiment, the friction stir welding process is performed by inserting the rotating tool 20 from the upper side of the current collecting tabs 3, the external terminal 4, and the cover block 5 (the side of the upper surface 32 of the current collecting tabs 3, the upper surface 42 of the external terminal 4, and the upper surface 52 of the cover block 5). This results in the stack 2 and the joint 6 being disposed away from each other via the external terminal 4 and the cover block 5. This readily prevents, for example, burrs produced during the friction stir welding process from entering the stack 2 as the burrs are separated and dispersed for some reason.

Additionally, the joining method according to the embodiment eliminates the need for a joining step performed on the side of a bottom surface of the external terminal 4 (specifically, in a space between the stack 2 and the external terminal 4), unlike the secondary battery disclosed in patent document 1. This prevents the stack 2 from being contacted therewith and damaged during the joining step. Additionally, because there is no need to perform the joining step on the side of the bottom surface of the external terminal 4, there is no need to allocate a working space on the side of the bottom surface and the folding structure as in patent document 1 can be eliminated.

In the secondary battery 1 according to the first embodiment, the routing performance of the current collecting tabs 3 can be improved and the electric resistance can be reduced, thereby the trend in secondary batteries toward greater capacities and larger current can be responded to. The secondary battery 1 according to the first embodiment is further advantageous in that the smaller space requirement occupied by the current collecting tabs 3 in the battery can 10 permits a more compact secondary battery 1 and higher energy density per volume.

### Second Embodiment

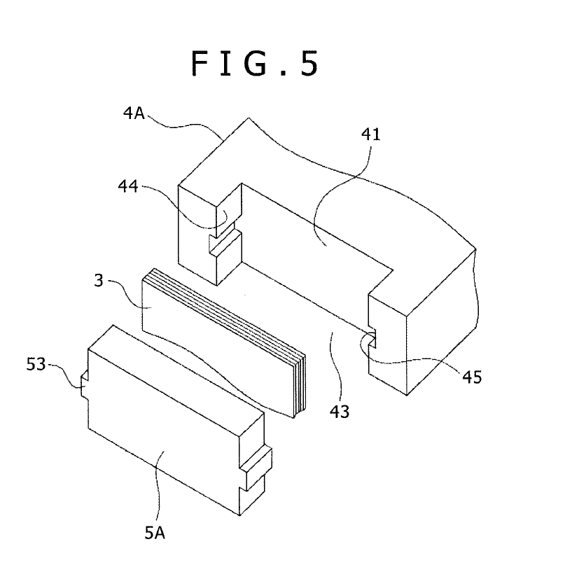

A secondary battery 1 according to a second embodiment will be described below with reference to FIG. 5. FIG. 5 is a partial enlarged perspective view showing the current collecting tabs 3, an external terminal 4A, a cover block 5A, and an area therearound in the secondary battery 1 according to the second embodiment. The secondary battery 1 according to the first embodiment and the secondary battery 1 according to the second embodiment differ from each other in the structure of the external terminal 4A and the cover block 5A. The secondary battery 1 according to the second embodiment is identical to the secondary battery 1 according to the first embodiment in other respects and descriptions for those similarities will be omitted.

The external terminal 4A has a side surface 41 that has a cutout 43 formed therein. The cutout 43 has cutout side surfaces 44 in each of which a recess 45 is formed, the recess 45 extending in a direction in which the cover block 5A is pressed.

The cover block 5A has protrusions 53 formed thereon.

When the current collecting tabs 3, the external terminal 4A, and the cover block 5A are to be joined together, the bundled current collecting tabs 3 is disposed between the external terminal 4A and the cover block 5A and then the cover block 5A is pressed toward the external terminal 4A. This causes the protrusions 53 of the cover block 5A to be fitted into the recesses 45 of the external terminal 4A, so that a main unit of the cover block 5A can be inserted into the cutout 43 in the external terminal 4A.

This improves workability involved when the cover block 5A is pressed toward the external terminal 4A. When a rotating tool 20 is to be inserted, the cover block 5A is locked in position by the recesses 45 and the protrusions 53, which improves workability of the friction stir welding process.

### Third Embodiment

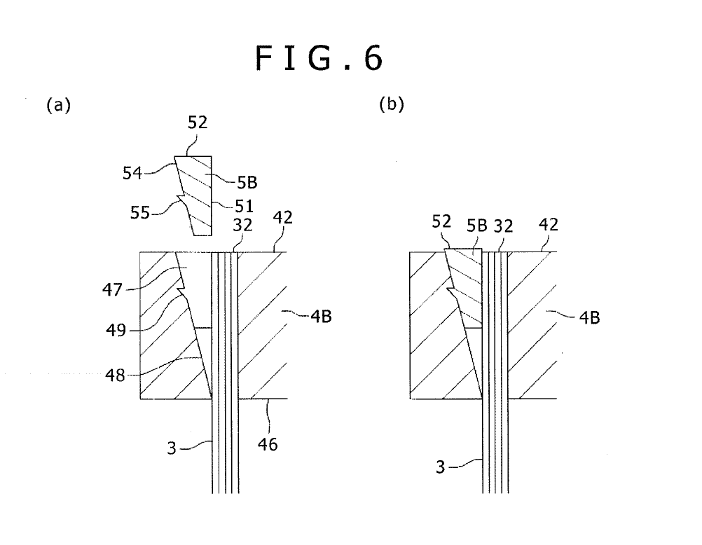

A secondary battery 1 according to a third embodiment will be described below with reference to FIGS. 6(a) and 6(b). FIGS. 6(a) and 6(b) are partial enlarged schematic views, each showing the current collecting tabs 3, an external terminal 4B, a cover block 5B, and an area therearound in the secondary battery 1 according to the third embodiment. The secondary battery 1 according to the first embodiment and the secondary battery 1 according to the third embodiment differ from each other in the structure of the external terminal 4B and the cover block 5B. The secondary battery 1 according to the third embodiment is identical to the secondary battery 1 according to the first embodiment in other respects and descriptions for those similarities will be omitted.

As shown in FIG. 6(a), the external terminal 4B has a through groove 47 into which the current collecting tabs 3 are inserted from a bottom surface 46 of the external terminal 4B and passed all the way up to the side of an upper surface 42 of the external terminal 4B. The through groove 47 has an inclined surface 48 such that the through groove 47 has an opening width widening toward the upper surface 42 from the bottom surface 46. Additionally, the inclined surface 48 has a recess 49 formed midway therein.

The cover block 5B has a side surface 51 and an inclined surface 54 that is positioned on the side opposite to the side surface 51. The inclined surface 54 has a protrusion 55 formed midway thereon.

When the current collecting tabs 3, the external terminal 4B, and the cover block 5B are to be joined together, the bundled current collecting tabs 3 are inserted into the through groove 47 from the side of the bottom surface 46 of the external terminal 4B. At this time, the upper surface 32 of the current collecting tabs 3 and the upper surface 42 of the external terminal 4B are flush with each other.

Next, the cover block 5B is pressed to be inserted into the through groove 47 from the side of the upper surface 42 of the external terminal 4B. At this time, the inclined surface 54 of the cover block 5B slides along the inclined surface 48 of the through groove 47, while bringing the current collecting tabs 3 into tight contact with each other with no gap allowed therebetween (see FIG. 6(b)) until the cover block 5B is pressed into the position at which the protrusion 55 fits in the recess 49. At this time, the upper surface 52 of the cover block 5B is disposed at a level higher than the upper surface 42 of the external terminal 4B and the upper surface 32 of the current collecting tabs 3.

Then, while a spinning rotating tool 20 is being spun, the rotating tool leading end 21 is pressed up against, and inserted into, the upper surface 52 of the cover block 5B. The initial pressing of the rotating tool leading end 21 against the upper surface 52 of the cover block 5B causes the step of inserting the rotating tool 20 to provide also a pressing force to bring the current collecting tabs 3 into tight contact with each other. This eliminates a separate mechanism to give the pressing force, thus improving workability of steps performed in areas around the joint.

The rotating tool 20 is further advanced until a bottom surface of the rotating tool 20 contacts the upper surface 42 of the external terminal 4B and the upper surface 32 of the current collecting tabs 3. The rotating tool 20 is then retained for two seconds before being moved in a direction opposite to the inserting direction and retracted from the joint. This spot joining sequence is performed twice at an identical joint.

The foregoing steps allow a rise in temperature of the external terminal 4B and the current collecting tabs 3 during the friction stir welding process to be reduced, compared with a case in which the rotating tool 20 is continuously (linearly) moved.

### Modifications

It is understood that the embodiments described above are not intended to limit the scope of the invention and various changes may be made without departing from the spirit of the invention.

While the above embodiments describe secondary batteries having a stacked electrode structure, the present invention is not limited thereto. For example, the secondary battery may have a wound electrode structure.

While the above embodiments describe secondary batteries having a can (battery can) as the housing structure, the present invention is not limited thereto. For example, the housing may be a laminate film.

In addition, while the secondary batteries have been described to have a rectangular parallelepiped shape, the present invention is not limited thereto. For example, the battery may be cylindrical or flat.

While the above embodiments describe lithium-ion secondary batteries, the present invention is not limited thereto. For example, the present invention may be applied to a nickel-metal hydride rechargeable battery or a secondary battery of any other configuration. The metallic current collector and the active material layer of the stack 2 may also be modified as appropriate according to the configuration of the secondary battery.

The first and second embodiments describe the formation of the joint 6 through the friction stir welding process in which the rotating tool 20 is moved continuously (linearly) and the third embodiment describes that in which the joining process is achieved by the spot joining process. Nonetheless, the spot joining process may be performed in the first and second embodiments and the rotating tool 20 may be moved continuously (linearly) in the third embodiment to thereby form the joint by the friction stir welding process.

While the above embodiments exemplarily describe the joint formed in the current collecting tabs 3, the external terminals 4 (4A, 4B), and the cover block 5 (5A, 5B), the present invention is not limited thereto. The present invention may be applied, more generally, to a joint structure that joins a foil assembly, a connecting member that fixes the foil assembly, and a holding member.

### DESCRIPTION OF REFERENCE NUMERALS

1 secondary battery
2 stack
3 current collecting tab (foil assembly)
4, 4A, 4B external terminal (connecting member)
5, 5A, 5B cover block (holding member)
6 joint
10 battery can
11 lid plate
12 electrolyte pouring hole plug
13 safety valve
20 rotating tool
21 rotating tool leading end
31 plane
32 upper surface (end face of a foil assembly)
41 side surface
42 upper surface
43 cutout
44 cutout side surface
45 recess
46 bottom surface
47 through groove
48 inclined surface
49 recess
50 side surface
52 upper surface
53 protrusion
54 inclined surface
55 protrusion

1. A joint structure comprising:
a foil assembly including a plurality of foils stacked one on top of the other;
a connecting member that fixes the foil assembly; and
a holding member disposed such that gaps in the foil assembly in the stacking direction are brought into tight contact with each other between the connecting member and the holding member;
wherein an end face of the foil assembly, the connecting member, and the holding member are joined integrally with each other.

2. The joint structure according to claim 1,
wherein the joining is metallically achieved by friction stir welding.

3. A joining method comprising:
disposing a holding member and a connecting member so as to bring gaps in a foil assembly in a stacking direction thereof into tight contact with each other between the connecting member and the holding member, the foil assembly including a plurality of foils stacked one on top of the other; and
joining an end face of the foil assembly, the connecting member, and the holding member integrally with each other.

4. The joining method according to claim 3,
wherein the joining is metallically achieved by friction stir welding.

5. A secondary battery comprising:
a stack including metallic current collectors stacked one on top of the other;
current collecting tabs each extending from the respective metallic current collectors;
an external terminal that fixes the current collecting tabs;
a holding member disposed such that gaps in the current collecting tabs in the stacking direction are brought into tight contact with each other between the external terminal and the holding member; and
a joint disposed, relative to the external terminal, on a side different from a side on which the stack is disposed, the joint joining the current collecting tabs, the external terminal, and the holding member.

6. The secondary battery according to claim 5,
wherein the joint is formed through joining of the current collecting tabs in a lateral direction relative to a stacking direction of the current collecting tabs.

7. The secondary battery according to claim 5,
wherein the current collecting tabs each have a length substantially equal to a length of half of thickness of the stack of the metallic current collectors in a stacking direction plus a height of a side surface of the external terminal.

8. The secondary battery according to claim 5,
wherein the current collecting tabs are housed without being folded in a meandering form.

9. The secondary battery according to claim 5,
wherein the joint is formed through friction stir welding which achieves joining metallically.

10. A method of manufacturing a secondary battery, the method comprising:
disposing an external terminal and a cover block so as to bring gaps in current collecting tabs in a stacking direction thereof into tight contact with each other, the current collecting tabs extending from metallic current collectors; and
joining an end face of the current collecting tabs, the external terminal, and the cover block integrally with each other, on a side different from a side on which a stack including the metallic current collectors stacked one on top of the other is disposed, relative to the external terminal.

11. The method of manufacturing a secondary battery according to claim 10,
wherein the joining is metallically achieved by friction stir welding.
